(19) United States
(12) Patent Application Publication
(10) Pub. No.: US 2005/0002290 A1
(43) Pub. Date: Jan. 6, 2005

(54) Optical disc apparatus and still operation method capable of performing still operation without deteriorating optical disc

(75) Inventors: Kenichi Ishizuka, Tokyo (JP); Shinichi Katsuda, Tokyo (JP)

Correspondence Address: OSTROLENK FABER GERB & SOFFEN, 1180 AVENUE OF THE AMERICAS, NEW YORK, NY, 100368403, US

(73) Assignee: NEC Corporation

(21) Appl. No.: 10/856,233

(22) Filed: May 28, 2004

(30) Foreign Application Priority Data
May 30, 2003 (JP) 2003-154689

(51) Int. Cl. G11B 7/00; G11B 5/09

(52) U.S. Cl. 369/44.28; 369/47.11

(57) ABSTRACT

An optical disc apparatus capable of performing a still operation includes a circulation-number counter (4) counting a circulation number of the optical disc (1) and a control unit (6) obtaining the accumulated circulation number (4) of the optical disc (1) after start of the still operation from the circulation-number counter (4) and, when the accumulated circulation number attains a predetermined circulation number n (n>1) as said predetermined value, controlling the pickup (3) so as to perform a track-jump for being placed back by n tracks toward the start position of reading the optical disc (1).

This application claims priority to prior Japanese patent application JP 2003-154689, the disclosure of which is incorporated herein by reference.

### BACKGROUND OF THE INVENTION

The present invention relates to an optical disc apparatus, and more particularly, it relates to an optical disc apparatus capable of performing a still operation.

An optical disc apparatus reproduces (reads) information or data from and/or records (writes) it into an optical disc or a magneto-optical disk (hereinafter, simply referred to as an optical disc) such as an LD (Laser Disc), a CD (Compact Disc), a CD-ROM (CD-Read Only Memory), a CD-R (CD-Recordable), a CD-RW (CD-ReWritable), a DVD-ROM (Digital Versatile (Video) Disc-ROM), a DVD-R, a DVD-RW, a DVD-RAM (DVD-Random Access Memory), a DVD+R, a DVD+RW, an MO (Magneto-Optical disk), or an MD (Mini Disc).

In general, the optical disc apparatus irradiates an optical disc with laser beam focused by a pickup at the time of reading data and traces tracks one after another by using a focus servo and a track servo, spirally formed on the optical disc.

During a temporary halt or during standby after reading data, the optical disc apparatus does not halt a series of actions of the pickup but cause the pickup to perform a track-jump by a single track every rotation of the optical disc toward the start position of playing back the optical so as to repeatedly trace an arbitrary track corresponding to one circulation. Such an operation is called a still operation.

A known optical disc apparatus generally performs as follows. Namely, the optical disc apparatus, after reading out data of ten tracks, lies on standby for a predetermined period with repeatedly tracing (applying a still operation on) a tenth track. Then, the optical disc apparatus reads out data of subsequent ten tracks and lies on standby for the predetermined period with repeatedly tracing a twentieth track again. Hereafter, the optical disc repeats the reading and the standby with repeatedly tracing. Therefore, particular tracks (e.g. the tenth and the twentieth tracks) are exposed to laser beam for a long period during the still operation by the optical disc apparatus.

In recent years, a wavelength of a laser beam source of an optical disc apparatus becomes shorter along with enhancement of a recording density of an optical disc. This trend causes a transparent substrate of the optical disc to absorb a larger amount of beam. A material such as polycarbonate forming the transparent substrate has a low transmittance with respect to laser beam having a short wavelength.

Accordingly, repetitive irradiation of tracks in question with laser beam due to the still operation causes a part of the transparent substrate corresponding to the tracks in question to induce a photochemical reaction, thereby leading to deterioration of the optical disc itself or data to be played back from the optical disc.

To solve such problems, for example, Japanese Patent Application Publication (JP-A) No. 2001-34944 discloses a method for reducing damage on the substrate by reducing a laser power during the still operation.

Alternatively, during the still operation, data may be stored in a buffer memory and an operation of the optical disc apparatus may be halted.

Also, for example, Japanese Patent Application Publication (JP-A) No. H7-262697 discloses a method for reducing damage on a data area by previously disposing the data area and a retraction area in an optical disc, and by seeking the retraction area during the still operation.

Unfortunately, with respect to the method of reducing a laser power, there is no room for reducing the laser power since the laser power needed during the still operation is often set at a minimum necessary for a normal playback operation.

With respect to the method of storing data in a buffer memory during the still operation and halting the still operation of the optical disc apparatus, an additional time is needed before restart of a reading operation since the reading operation is restarted after the focus servo and the track servo are restarted, an address in the optical disc is detected, and a reading position is corrected after release of the still operation.

Also, with respect to the method of seeking a retraction area previously disposed in an optical disc during the still operation, the storage capacity of the optical disc is reduced by an amount corresponding to the retraction area, and an additional time is needed for a seek time between after the still operation before return to the data area.

### SUMMARY OF THE INVENTION

It is therefore an object of the present invention to provide an optical disc apparatus capable of performing a still operation without deterioration of an optical disc.

In accordance with one aspect of the present invention, an optical disc apparatus is capable of performing a still operation for an optical disc, the optical disc being provided with tracks. The tracks is formed so as to increase by a single track every circulation of the optical disc. The apparatus comprises a control unit obtaining a trace progress after start of the still operation and controlling, when the trace progress attains a predetermined value (the predetermined value>an equivalent value for one track), the pickup to perform the track-jump so that the pickup is placed back by at least the predetermined value toward the start position of reading the optical disc.

In accordance with another aspect of the present invention, a method for performing a still operation of an optical disc apparatus is capable of performing a still operation for an optical disc, the optical disc being provided with tracks. The tracks is formed so as to increase by a single track every circulation of the optical disc. The method comprises the steps of: obtaining a trace progress after start of the still operation, and controlling, when the trace progress attains a predetermined value (the predetermined value>an equivalent value for one track), the pickup to perform the track-jump so that the pickup is placed back by at least the predetermined value toward the start position of reading the optical disc.

In accordance with still another aspect of the present invention, a computer program for an optical disc apparatus is capable of performing a still operation for an optical disc, the optical disc being provided with tracks. The tracks is formed so as to increase by a single track every circulation of the optical disc. The program comprises the steps of: obtaining a trace progress after start of the still operation, and controlling, when the trace progress attains a predetermined value (the predetermined value>an equivalent value for one track), the pickup to perform the track-jump so that the pickup is placed back by at least the predetermined value toward the start position of reading the optical disc.

Other aspects, features, and advantages of the present invention will become clear as the description proceeds.

### BRIEF DESCRIPTION OF THE DRAWINGS

FIG. 1 is an illustration of an operation of an optical disc apparatus as an example existing art, illustrating the relationship between time and track position;

FIG. 2 is an illustration of a transmittance vs. wavelength characteristic of polycarbonate;

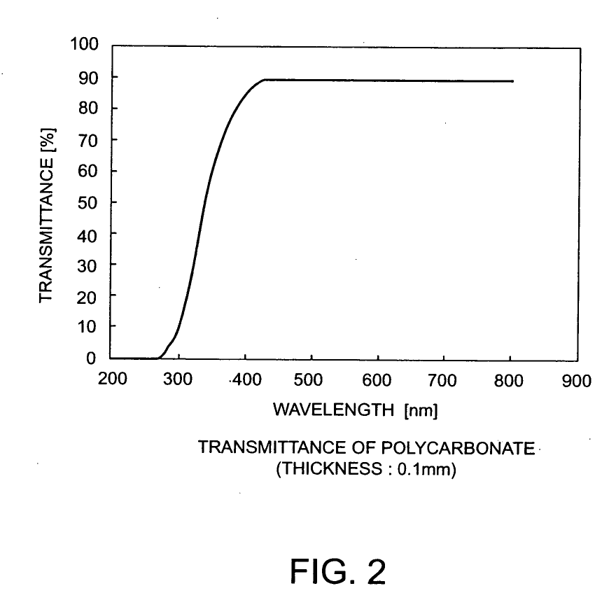

FIG. 3 is a block diagram illustrating the structure of an optical disc apparatus according to a first embodiment of the present invention;

FIG. 4 is a block diagram illustrating the structure of a control unit of the optical disc apparatus according to the first embodiment of the present invention;

FIG. 5 is a flowchart illustrating an operation of the optical disc apparatus according to the first embodiment of the present invention;

FIG. 6 is an illustration of the operation of the optical disc apparatus according to the first embodiment of the present invention, illustrating the relationship between time and track position;

FIG. 7 is a block diagram illustrating the structure of a control unit of an optical disc apparatus according to a second embodiment of the present invention;

FIG. 8 is a flowchart illustrating an operation of the optical disc apparatus according to the second embodiment of the present invention;

FIG. 9 is an illustration of the operation of the optical disc apparatus according to the second embodiment or an operation of an optical disc apparatus according to a third embodiment of the present invention, illustrating the relationship between time and track position;

FIG. 10 is a block diagram illustrating the structure of the optical disc apparatus according to the third embodiment of the present invention;

FIG. 11 is a bloc diagram illustrating the structure of a control unit of the optical disc apparatus according to the third embodiment of the present invention;

FIG. 12 is a flowchart illustrating the operation of the optical disc apparatus according to the third embodiment of the present invention; and

FIGS. 13A, 13B, and 13C illustrate a concept about tracks of an optical disc, introduced in the specification of the present invention.

### DESCRIPTION OF THE PREFERRED EMBODIMENTS

In order to facilitate an understanding of the present invention, description will at first be made with reference to the drawings about an existing art described in the preamble of this specification.

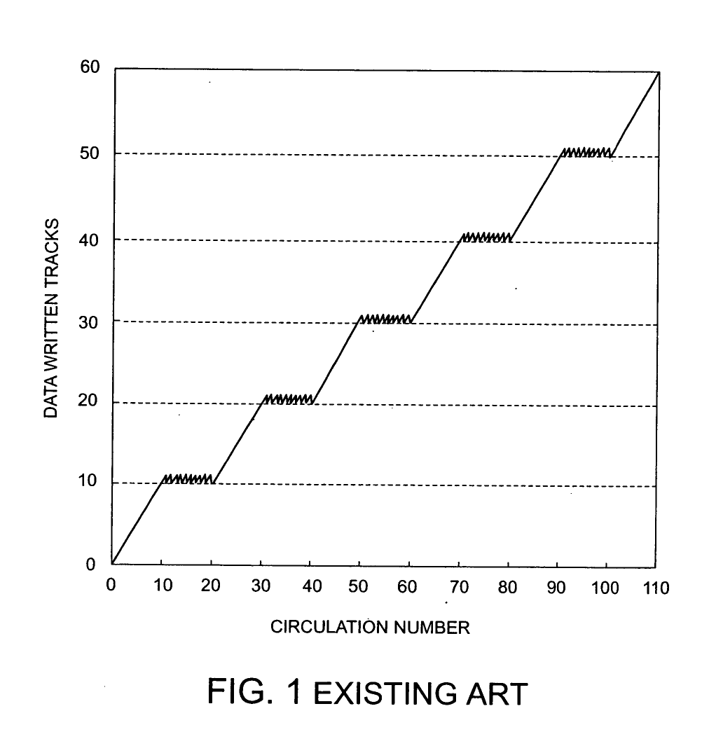

FIG. 1 illustrates the relationship of an optical disc between circulation number and data-written tracks, during a still operation of an optical disc apparatus as an example existing art. In the case shown in FIG. 1, the optical disc apparatus performs as follows. Namely, the optical disc apparatus, after reading out data of ten tracks, lies on standby for a predetermined period with repeatedly tracing (applying a still operation on) a tenth track. Then, the optical disc apparatus reads out data of subsequent ten tracks and lies on standby for the predetermined period with repeatedly tracing a twentieth track again. Hereafter, the optical disc repeats the reading and the standby with repeatedly tracing. Therefore, particular tracks (e.g. the tenth and the twentieth tracks) are exposed to laser beam for a long period during the still operation by the optical disc apparatus.

Now, preferred embodiments of the present invention will be described with reference to the attached drawings.

In the embodiments, a still operation of an optical apparatus for an optical disc is an operation such that an arbitrary order track of tracks formed on the optical disc is repeatedly traced by a pickup.

First Embodiment

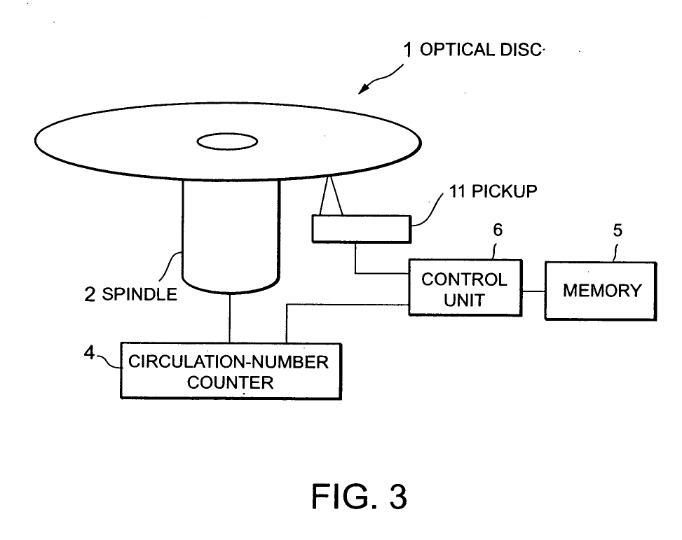

Referring to FIG. 3, an optical disc apparatus according to a first embodiment of the present invention includes a spindle 2 rotating an optical disc 1, a pickup 3 reading data from the optical disc 1 rotated by the spindle 2, a circulation-number counter 4 counting a circulation number of the spindle 2, a memory 5 storing a set value of a circulation number, a still-operation-release interrupt command, and so forth, which will be described later, and a control unit 6 controlling these elements.

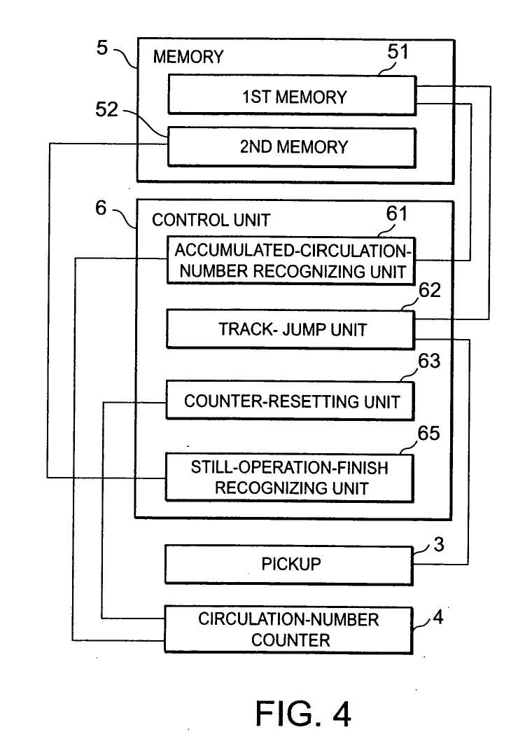

Referring to FIG. 4, the memory 5 includes a first memory 51 storing a set value n (n>1) of the circulation number, and a second memory 52 storing the still-operation-release interrupt command, which will described later.

The control unit 6 includes an accumulated-circulation-number recognizing unit 61 recognizing whether or not a counted value of the circulation-number counter 4 attains the predetermined circulation number n stored in the first memory 51 of the memory 5, a track-jump unit 62 causing the pickup 3 to perform a track-jump for being placed back by n tracks toward the start position of reading the optical disc 1 when the accumulated-circulation-number recognizing unit 61 recognizes that the counted value of the circulation-number counter 4 attains the predetermined circulation number n stored in the first memory 51 of the memory 5, a counter-resetting unit 63 resetting the counted value of the circulation-number counter 4 when the track-jump unit 62 causes the pickup 3 to perform a track-jump, and a still-operation-finish recognizing unit 65 recognizing whether or not a still operation is finished, on the basis of the still-operation-release interrupt command, which will be described later.

Meanwhile, at least a part of the control unit 6 may be implemented by a program previously stored in (a memory included in) a computer having a chip shape or the like.

An operation of the above-described optical disc apparatus will be described below.

The optical disc apparatus according to the first embodiment generally irradiates the optical disc 1 with laser beam emitted from the pickup 3 at the time of reading data and traces tracks spirally formed on the optical disc 1, one after another by using a focus servo and a track servo. During a temporary halt or during standby after reading the data, the optical disc apparatus does not halt a series of actions of the pickup but moves to performing a still operation.

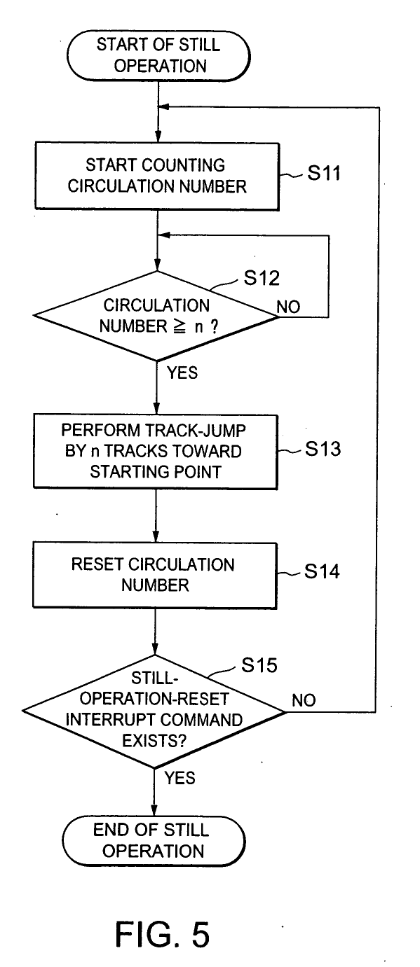

As shown in FIGS. 3 to 5, when the optical disc apparatus according to the first embodiment starts a still operation, the circulation-number counter 4 starts counting a circulation number (in Step S11) in accordance with an instruction of the control unit 6. During counting, the pickup 3 does not perform a track-jump but traces the spirally formed tracks.

Then, the accumulated-circulation-number recognizing unit 61 of the control unit 6 monitors a circulation number counted by the circulation-number counter 4 until the circulation number attains the value n previously stored in the first memory 51 of the memory 5 (in Step S12).

Meanwhile, the value n previously stored in the memory 5 is an integer satisfying the condition: n>1 and is set at 5 in the present embodiment.

When a circulation number counted by the circulation-number counter 4 attains n, the track-jump unit 62 of the control unit 6 instructs driving means (not shown) of the pickup 3 so that the pickup 3 performs a track-jump toward the starting point of the optical disc 1 by n tracks (in Step S13). Then, the counter-resetting unit 63 of the control unit 6 resets the circulation number counted by the circulation-number counter 4 to zero (in Step S14).

In order to release the still operation, a still-operation-release interrupt command is provided to the optical disc apparatus with an arbitrary timing. The control unit 6 temporarily stores the received still-operation-release interrupt command in the second memory 52 of the memory 5.

When the memory 5 has received the still-operation-release interrupt command and stored it in the second memory 52 thereof up to now, the still-operation-finish recognizing unit 65 of the control unit 6 erases the still-operation-release interrupt command and then causes the optical disc apparatus to finish the process and to return to a normal reading operation. When the second memory 52 does not have still-operation-release interrupt command stored therein, the still-operation-finish recognizing unit 65 causes the optical disc apparatus to repeat the operation flow from the beginning (in Step S15).

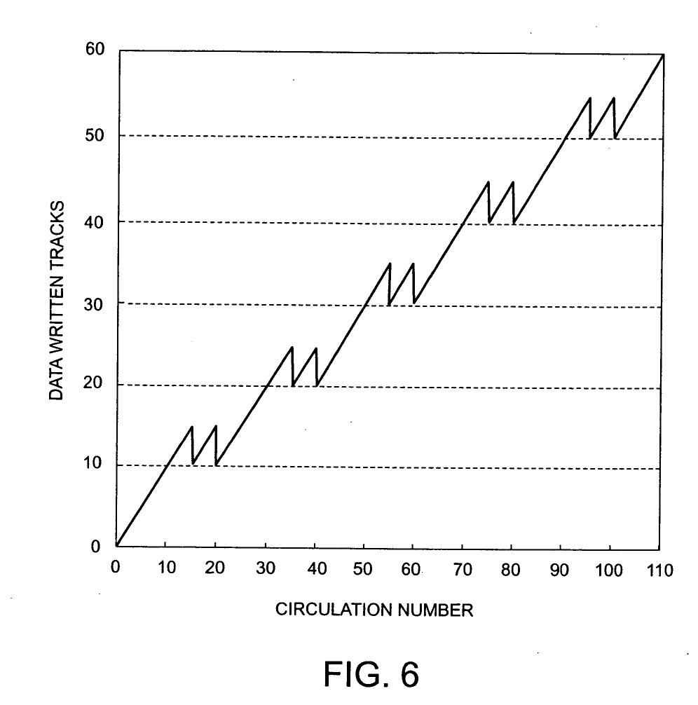

FIG. 6 illustrates the still operation of the optical disc apparatus according to the first embodiment, that is, illustrates the relationship of the optical disc between circulation number and data-written tracks, with the condition: n=5.

As shown in FIG. 6, the optical disc apparatus according to the first embodiment performs a repetitive operation of reading 10 tracks in a normal manner, then lying on standby for a predetermined period of time, subsequently reading subsequent 10 tracks, and lying on standby for the predetermined period of time.

With the condition: n=5, in the optical disc apparatus according to the present embodiment, the pickup does not perform a track-jump until the circulation number attains 5. When the circulation number attains 5, that is, the optical disc apparatus traces up to the 15th track, the pickup performs a track-jump by 5 tracks toward the start position of reading the optical disc, that is, returns to the start position of the 11th track (that is, the end position of the 10th track).

As is apparent from FIG. 6, when a pickup performing a track-jump every circulation, of a known optical disc apparatus traces a track in question 10 times, the pickup of the optical disc apparatus according to the present embodiment traces a track in question only twice.

Although the above-described apparatus according to the first embodiment performs a control by using a circulation number in units of tracks as a trace progress, the apparatus according to the present invention may perform a control by using a progress in units of addresses (blocks) as a trace progress.

Second Embodiment

As shown in FIG. 3, in the same fashion as in the first embodiment, an optical disc apparatus according to a second embodiment of the present invention includes the spindle 2 rotating the optical disc 1, the pickup 3 reading data from the rotating optical disc 1, the circulation-number counter 4 counting a circulation number of the spindle 2, the memory 5 storing a set value of a circulation number, a still-operation-release interrupt command, an original address, an additional value of a track-jump, and so forth, which will be described later, and a control unit 7 controlling these elements.

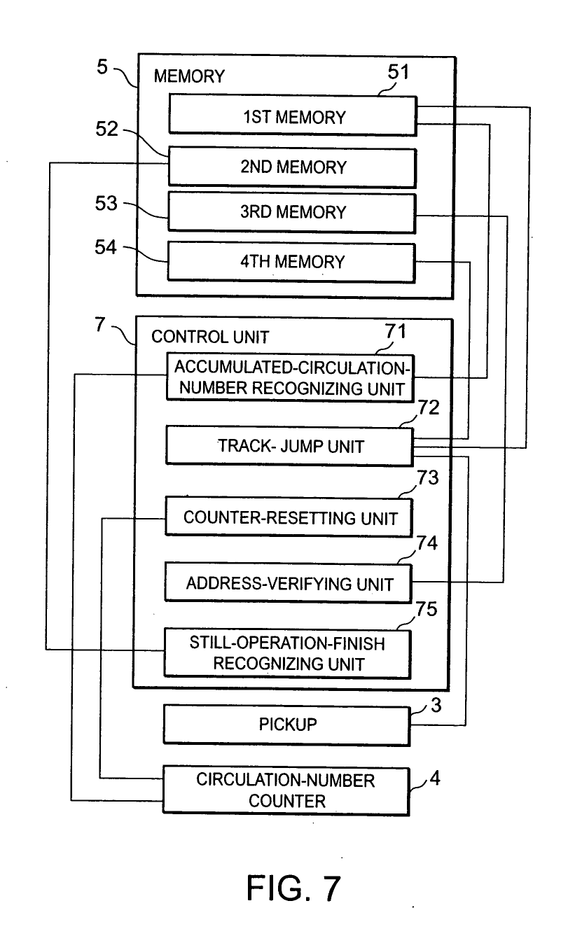

As shown in FIG. 7, the memory 5 includes the first memory 51 storing a set value n (n>1) of the circulation number, the second memory 52 storing the still-operation-release interrupt command, which will described later, a third memory 53 storing the original address, and a fourth memory 54 storing an additional value α of a track-jump (α≧1), which will be described later.

The control unit 7 includes an accumulated-circulation-number recognizing unit 71 recognizing whether or not a counted value of the circulation-number counter 4 attains the predetermined circulation number n stored in the first memory 51 of the memory 5, a track-jump unit 72 referring to the first and fourth memories 51 and 54 of the memory 5 when the accumulated-circulation-number recognizing unit 71 recognizes that the counted value of the circulation-number counter 4 attains the predetermined circulation number n stored in the first memory 51 of the memory 5 and causing the pickup 3 to perform a track-jump for being placed back by (n+α) tracks toward the start position of reading the optical disc 1, a counter-resetting unit 73 resetting the counted value of the circulation-number counter 4 when the track-jump unit 72 causes the pickup 3 to perform a track-jump, an address-verifying unit 74 verifying the original address stored in the third memory 53 of the memory 5 and an address after the track-jump against each other when the counter-resetting unit 73 resets the counted value of the circulation-number counter 4, and a still-operation-finish recognizing unit 75 recognizing whether or not the still operation is finished, on the basis of the still-operation-release interrupt command, which will be described later.

Meanwhile, at least a part of the control unit 7 may be implemented by a program previously stored in (a memory included in) a computer having a chip shape or the like.

An operation of optical disc apparatus having the above-described structure will be described below.

In the same fashion as in the first embodiment, the optical disc apparatus according to the second embodiment generally irradiates the optical disc 1 with laser beam emitted from the pickup 3 at the time of reading data and traces tracks spirally formed on the optical disc 1, one after another by using a focus servo and a track servo. During a temporary halt or during standby after reading the data, the optical disc apparatus does not halt a series of actions of the pickup but moves to performing a still operation.

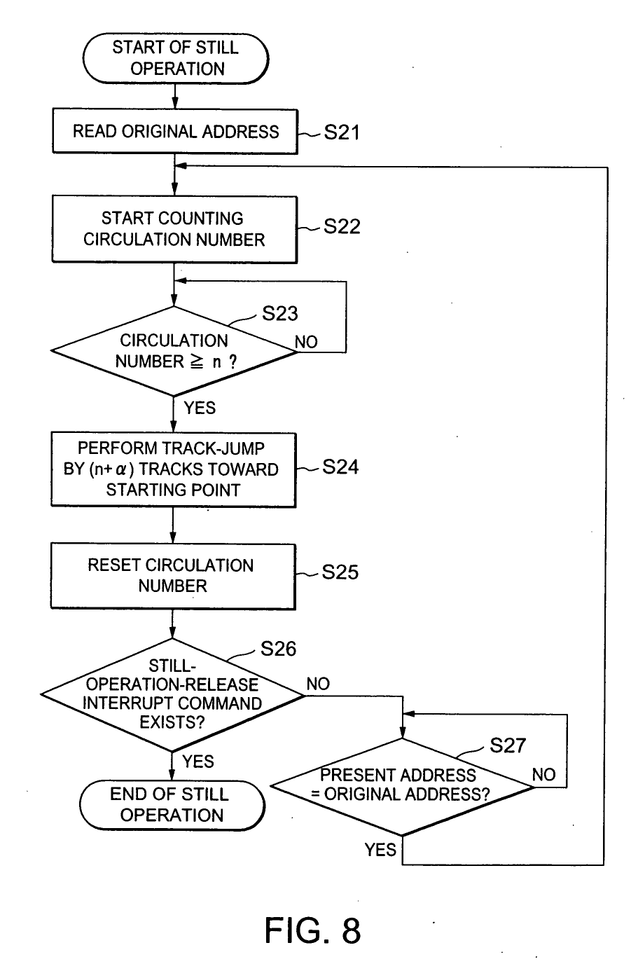

As shown in FIGS. 3, 7, and 8, when the optical disc apparatus according to the second embodiment starts a still operation, the control unit 7 reads the original address at the still-operation start position and stores it in the third memory 53 of the memory 5 (in Step S21).

Then, the circulation-number counter 4 starts counting a circulation number (in Step S22) in accordance with an instruction of the control unit 7. During counting, the pickup 3 does not perform a track-jump but traces the spirally formed tracks.

Subsequently, the accumulated-circulation-number recognizing unit 71 of the control unit 7 monitors the circulation number until the circulation number counted by the circulation-number counter 4 attains the circulation number n previously stored in the first memory 51 of the memory 5 (in Step S23).

Meanwhile, a notation n previously stored in the first memory 51 of the memory 5 is an integer satisfying the condition: n>1 and is set at 4 in the present embodiment.

When a circulation number counted by the circulation-number counter 4 attains n, the track-jump unit 72 of the control unit 7 instructs driving means (not shown) of the pickup 3 so that the pickup 3 performs a track-jump toward the starting point of the optical disc by (n+α) tracks so as to move to a track lying in front of the still-operation original position (in Step S24). Then, the counter-resetting unit 73 of the control unit 7 resets the circulation number of the circulation-number counter 4 to zero (in Step S25).

Meanwhile, the additional value α previously stored in the fourth memory 54 of the memory 5 is an integer equal to 1 or greater and is set at 1 in the present embodiment.

In order to release the still operation, a still-operation-release interrupt command is provided to the optical disc apparatus with an arbitrary timing. The control unit 7 temporarily stores the received still-operation-release interrupt command in the second memory 52 of the memory 5.

When the memory 5 has already received the still-operation-release interrupt command and stored it in the second memory 52 thereof up to now (in Step S26), the still-operation-finish recognizing unit 75 of the control unit 7 erases the still-operation-release interrupt command and then causes the optical disc apparatus to finish the process and to return to a normal reading operation.

When the control unit 7 has not received the still-operation-release interrupt command, the address-verifying unit 74 of the control unit 7 monitors a present address until it coincides with the original address stored in the third memory 53 of the memory 5 (in Step S27).

When the address-verifying unit 74 of the control unit 7 confirms that the present address coincides with the original address stored in the third memory 53 of the memory 5, the process returns to Step S22 of starting counting a circulation number and repeats the operation flow from this step.

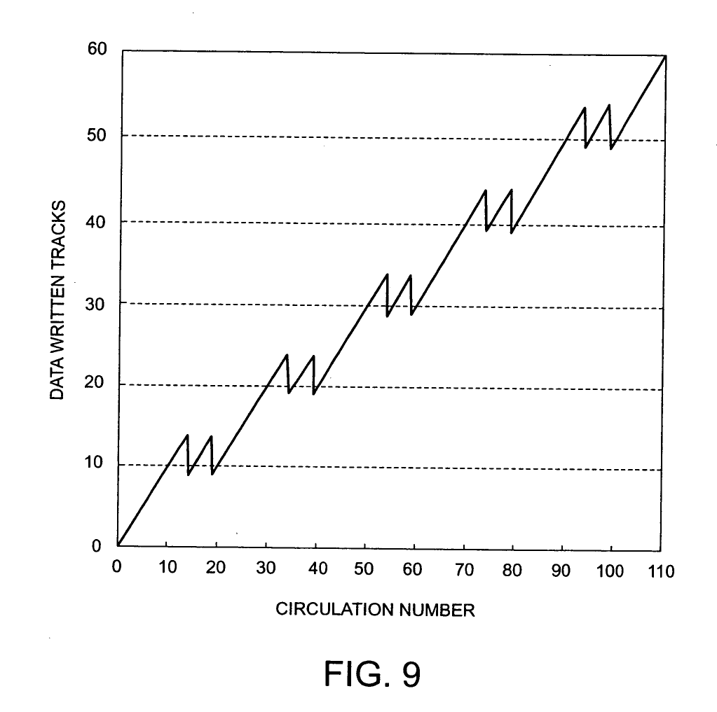

FIG. 9 illustrates the still operation of the optical disc apparatus according to the second embodiment, that is, illustrates the relationship of the optical disc between circulation number and data-written tracks, with the conditions: n=4 and α=1.

As shown in FIG. 9, the optical disc apparatus according to the second embodiment performs a repetitive operation of reading 10 tracks in a normal manner, then lying on standby for a predetermined period of time, subsequently reading subsequent 10 tracks, and lying on standby for the predetermined period of time.

With the conditions: n=4, and α=1, in the optical disc apparatus according to the present embodiment, the pickup does not perform a track-jump until the circulation number attains 4. When the circulation number attains 4, that is, the optical disc apparatus traces up to the 14th track, the pickup performs a track-jump by {(n+α)=(4+1)} tracks toward the start position of reading the optical disc, that is, returns to the start position of the 10th track (that is, the end position of the 9th track).

As is apparent from FIG. 9, when a pickup performing a track-jump every circulation, of a known optical disc apparatus traces a track in question 10 times, the pickup of the optical disc apparatus according to the present embodiment traces a track in question only twice.

Also, since the pickup is placed back additionally by a tracks when compared to that in the first embodiment, and the address position is confirmed, even when an unexpected situation occurs, for example, the pickup does not fully perform a track-jump for a set amount of tracks, the pickup is prevented from displacement when performing a still operation.

Although the above-described apparatus according to the second embodiment performs a control by using a circulation number in units of tracks as a trace progress in the same fashion as in the first embodiment, the apparatus according to the present invention may perform a control by using a progress in units of addresses (blocks) as a trace progress.

Third Embodiment

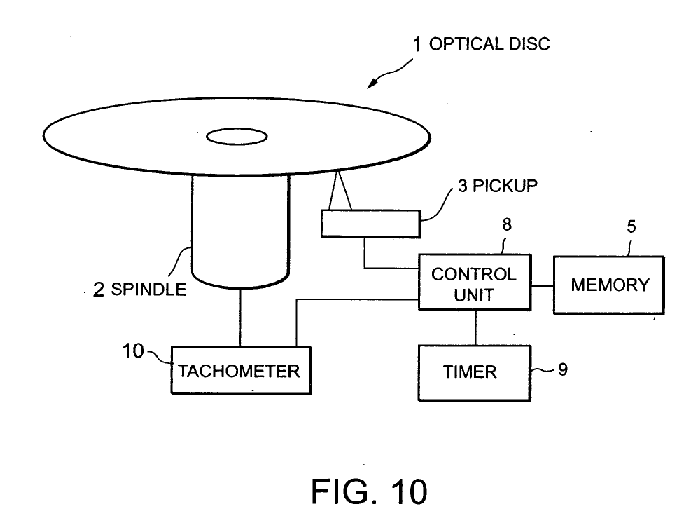

As shown in FIG. 10, an optical disc apparatus according to a third embodiment of the present invention includes the spindle 2 rotating the optical disc 1, the pickup 3 reading data from the rotating optical disc 1, a timer 9 measuring a trace time during a still operation, a tachometer 10 measuring a rotation speed r per unit time of the spindle, the memory 5 storing a set value of a still-operation elapsed-trace-time, a still-operation-release interrupt command, an original address, an additional value of a track-jump, and so forth, which will be described later, and a control unit 8 controlling these elements.

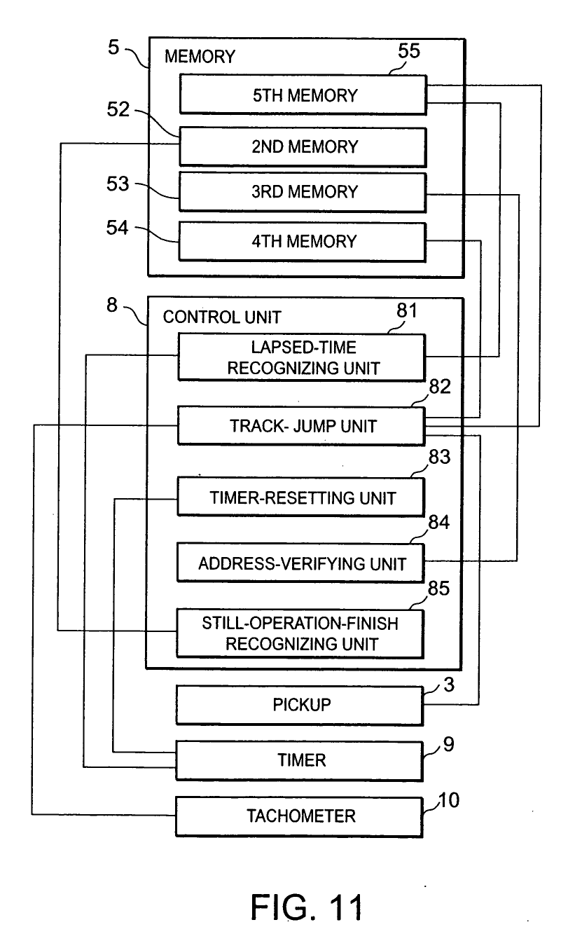

As shown in FIG. 11, the memory 5 includes the second memory 52 storing the still-operation-release interrupt command, which will described later, the third memory 53 storing the original address, the fourth memory 54 storing an additional value α (α>1) of a track-jump, which will be described later, and a fifth memory 55 storing a set value t of a still-operation elapsed-trace-time, which will be described later.

The control unit 8 includes an elapsed-time recognizing unit 81 recognizing whether or not an elapsed-trace-time measured by the timer 9 attains the predetermined time t stored in the fifth memory 55 of the memory 5, a track-jump unit 82 referring to the first and fourth memories 51 and 54 of the memory 5 and the rotation speed r measured by the tachometer 10 when the elapsed-time recognizing unit 81 recognizes that the elapsed-trace-time measured by the timer 9 attains the predetermined time t stored in the memory 5, and causing the pickup 3 to perform a track-jump for being placed back by (r×t+α) tracks toward the start position of reading the optical disc 1, a timer-resetting unit 83 resetting a measured time of the timer 9 when the track-jump unit 82 causes the pickup 3 to perform a track-jump, an address-verifying unit 84 verifying the original address stored in the third memory 53 of the memory 5 and an address after the track-jump against each other when the timer-resetting unit 83 resets the measured time of the timer 9 and causing the timer 9 to start measuring an elapsed-trace-time if the verification result is satisfactory, and a still-operation-finish recognizing unit 85 recognizing whether or not the still operation is finished, on the basis of the still-operation-release interrupt command, which will be described later.

Meanwhile, at least a part of the control unit 8 may be implemented by a program previously stored in (a memory included in) a computer having a chip shape or the like.

An operation of the optical disc apparatus having above-described structure will be described below.

In the same fashion as in the first and second embodiments, the optical disc apparatus according to the third embodiment generally irradiates the optical disc 1 with laser beam emitted from the pickup 3 at the time of reading data and traces tracks spirally formed on the optical disc 1, one after another by using a focus servo and a track servo. During a temporary halt or during standby after reading the data, the optical disc apparatus does not halt a series of actions of the pickup but moves to performing a still operation.

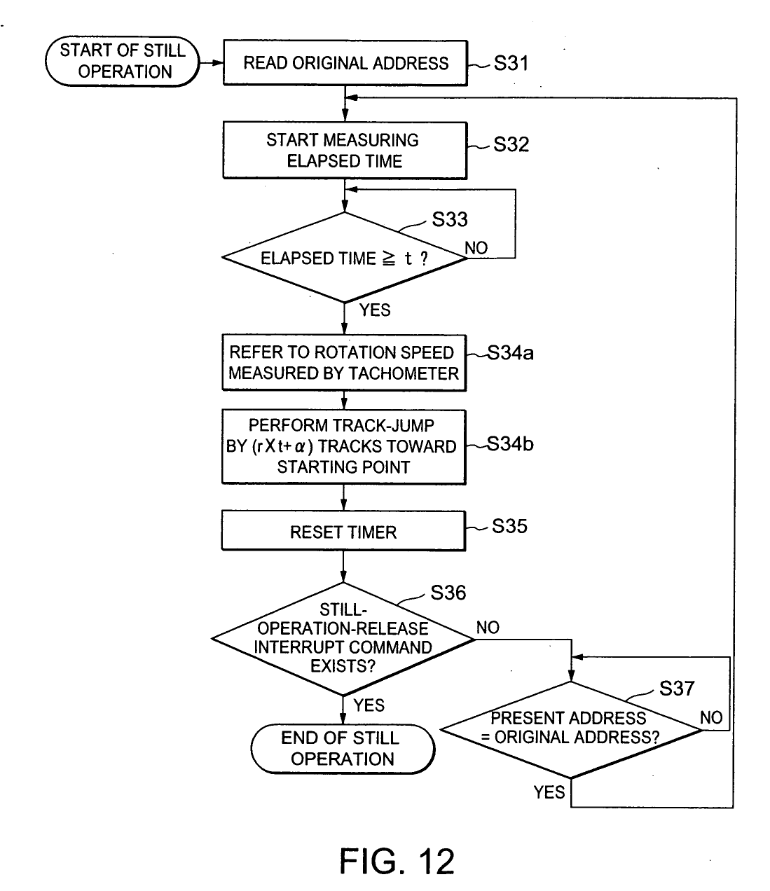

As shown in FIGS. 10 to 12, when the optical disc apparatus according to the third embodiment starts a still operation, the control unit 8 reads the original address at the still-operation start position and stores it in the third memory 53 of the memory 5 (in Step S31).

Then, the timer 9 starts measuring an elapsed-trace-time (in Step S32) in accordance with an instruction of the control unit 8. During counting, the pickup 3 does not perform a track-jump but traces the spirally formed tracks.

Subsequently, the elapsed-time recognizing unit 81 of the control unit 8 monitors an elapsed-trace-time measured by the timer 9 until the elapsed-trace-time attains the predetermined time t previously stored in the fifth memory 55 of the memory 5 (in Step S33).

Meanwhile, the value t previously stored in the fifth memory 55 of the memory 5 is a period of time needed for at least one rotation of the spindle 2 (optical disc 1) and is set at 1 second in the present embodiment.

When a measured time of the timer 9 attains t (1 second), the track-jump unit 82 of the control unit 8 refers to the rotation speed r of the tachometer 10 (set at 4 rpm in the third embodiment) (in Step S34a) and instructs driving means (not shown) of the pickup 3 to perform a track-jump by (r×t+α) tracks toward the starting point so as to move to a track in front of the still-operation original position (in Step S34b). Also, the timer-resetting unit 83 of the control unit 8 resets the elapsed-trace-time measured by the timer 9 to zero (in Step S35).

Meanwhile, the additional value α previously stored in the fourth memory 54 of the memory 5 is an integer equal to 1 or greater and is set at 1 in the present embodiment.

In order to release the still operation, a still-operation-release interrupt command is provided to the optical disc apparatus with an arbitrary timing. The control unit 8 temporarily stores the received still-operation-release interrupt command in the second memory 52 of the memory 5.

When the memory 8 has already received the still-operation-release interrupt command and stored it in the second memory 52 thereof up to now (in Step S36), the still-operation-finish recognizing unit 85 of the control unit 8 erases the still-operation-release interrupt command and then causes the optical disc apparatus to finish the process and to return a normal reading operation.

The control unit 8 has not received the still-operation-release interrupt command, the address-verifying unit 84 of the control unit 8 monitors a present address until it coincides with the original address stored in the third memory 53 of the memory 5 (in Step S37).

When the address-verifying unit 84 of the control unit 8 confirms that the present address coincides with the original address stored in the third memory 53 of the memory 5, the process returns to Step S32 of starting measuring an elapsed time and repeats the operation flow from this step.

FIG. 9 illustrates a still operation of the optical disc apparatus according to the third embodiment in the same fashion as illustrating that according to the second embodiment. In other words, FIG. 9 illustrates the relationship of the optical disc between circulation number (corresponding to an elapsed-trace-time) and data-written tracks, with the conditions: t=1, r=4, and α=1.

As shown in FIG. 9, the optical disc apparatus according to the third embodiment performs a repetitive operation of reading 10 tracks in a normal manner, then lying on standby for a predetermined period of time, subsequently reading subsequent 10 tracks, and lying on standby for the predetermined period of time.

With the conditions: t=1, r=4, and α=1, in the optical disc apparatus according to the third embodiment, the pickup does not perform a track-jump until the elapsed-trace-time attains 1 second. When the elapsed-trace-time attains 1, that is, when the pickup traces up to the 14th track, the pickup performs a track-jump by {(r×t+α)=(4×1+1)} tracks toward the start position of reading the optical disc, that is, returns to the start position or the original position of the 10th track (that is, the end position of the 9th track).

As is apparent from FIG. 9, when a pickup performing a track-jump every circulation, of a known optical disc apparatus traces a track in question 10 times, the pickup of the optical disc apparatus according to the present embodiment traces a track in question only twice.

Also, since the pickup is placed back additionally by α tracks when compared to that in the first embodiment, and the address position is confirmed, even when an unexpected situation occurs, for example, the pickup does not fully perform a track-jump for a set amount of tracks, the pickup is prevented from displacement at the time of the still operation.

The above-described apparatus according to the third embodiment performs a control by using a circulation number on the basis of an elapsed-trace-time and a rotation speed per unit time as a trace progress. Although the rotation speed is set at a constant value in the third embodiment for better understanding, in some optical disc apparatuses, a linear velocity is constant. Such a case can be coped by, for example, measuring the average rotation speed during a still operation.

Also, in the case of an optical disc apparatus having a structure in which an optical disc rotates at a constant linear velocity, by using an elapsed time t as a measured value in the same fashion as in the third embodiment, a trace length during the still operation can be made constant, whereby an effect of reducing deterioration of a substrate of the optical disc caused by the still operation, according to the present invention, can be made uniform both on outer and inner parts of an optical disc.

Last of all, a concept about tracks of an optical disc introduced in the specification of the present invention will be described.

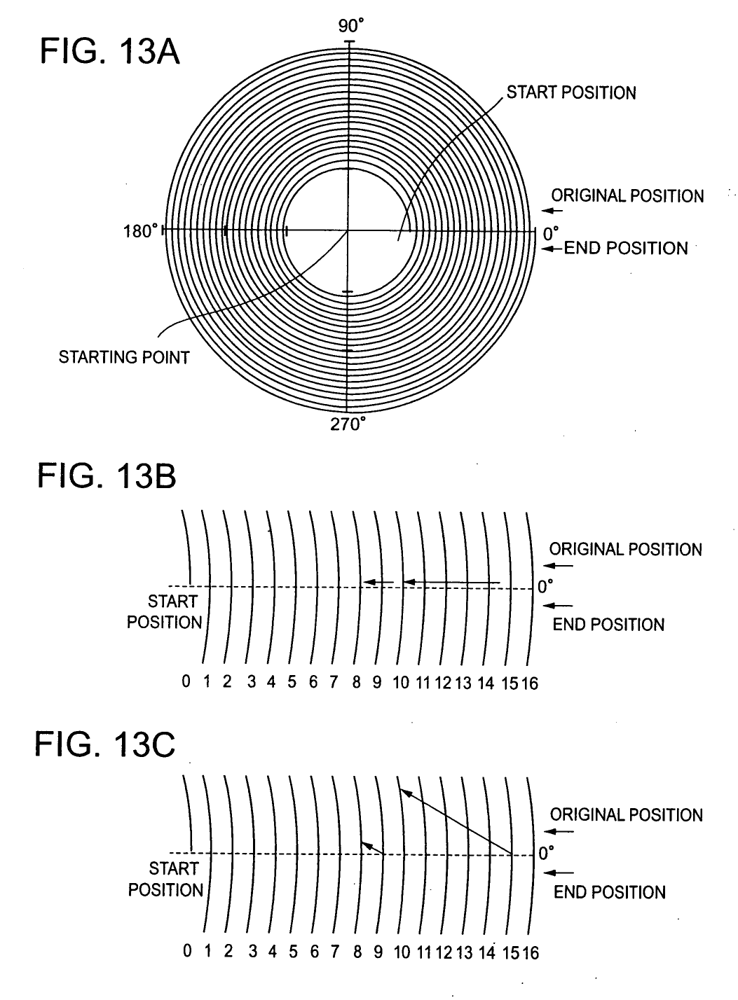

FIG. 13A is a schematic view of the track structure of an optical disc medium. FIG. 13B is a partial magnification of FIG. 13A, illustrating numbered tracks. The optical disc has a track structure formed by a single spirally-formed line. A portion of the track structure corresponding to one circulation is called a track, and the distance between adjacent tracks is called a track pitch.

As is obvious from FIGS. 13A and 13B, the optical disc has a structure in which the tracks increase by one track every circulation. Also, data is generally recorded from the start position (from the inner periphery) toward the outer periphery of the optical disc. An actual first track is formed by a circular line extending from the start position shown in FIG. 13B, that is, from a position of the number zero track, lying on the zero-degree line, to a position right in front of a position of the first track, lying on the zero-degree line. Since the optical disc is assumed to rotate clockwise in FIGS. 13A and 13B, each track has an original position and an end position right above and below the zero-degree line, respectively. The optical disc apparatus reads data stored in the tracks by causing the pickup to follow the tracks while causing the optical disc to rotate.

In the specification, a track-jump means an action of the pickup jumping inwardly or outwardly from a certain track from which the pickup is reading data as its trajectories are shown by the arrows indicated in FIG. 13B. Each part of each graph in FIGS. 1, 6, and 9 extending directly downward indicates an occurrence of a track-jump, that is, indicates that the track jump is completed in an instant (a nearly zero period of time or a negligible period of time).

Strictly speaking, since the optical disc is rotating clockwise during the track-jump, the track-jump is not completed in an instant, depending on the design of the optical disc apparatus (the pickup does not jump directly toward the starting point as shown in FIG. 13B). That is, when the trajectory of each track-jump is depicted taking a time period necessary for the track-jump into consideration, the trajectory extends obliquely upward as shown in FIG. 13C. In this case, the pickup does not trace a part of the optical disc lying between the zero-degree line shown in FIG. 13C and the top of corresponding arrow.

In the case of the optical disc apparatus according to the first embodiment of the present invention, when the length of the part of the optical disc which is not traced by the pickup exceeds a tolerable level from the viewpoint of a reading operation, data stored in the tracks lying in the above length of the optical disc is dropped out after finish of the still operation and upon start of reading the subsequent tracks.

In such a case, by adding an additional value α as in the second or the third embodiment, the pickup performs a track-jump further inwardly than the original position of the still operation, thereby solving a problem in that a part of the optical disc is not traced by the pickup, and thus preventing data from being dropped out.

As described above, since the optical disc apparatus according to the present invention performs a still operation while playing back data of a plurality of circulations (tracks), the number of repeatedly tracing a track in question per unit time can be reduced to a fraction of the number of circulations during the still operation.

With this structure, a photochemical reaction of a substrate of an optical disc due to absorption of a playback beam can be inhibited, and deterioration of the optical disc can be reduced.

Also, since the pickup is additionally placed back by a tracks, and an address position is confirmed, even when an unexpected situation occurs, for example, the pickup does not perform a track-jump for a set amount of tracks, the pickup is prevented from displacement when performing a still operation.

In addition, although a still operation is performed while playing back tracks corresponding to a predetermined number of circulations or a predetermined trace progress according to the present invention, an elapsed-trace-time may be measured so as to serve as a trace progress. In such a case, when an optical disc apparatus has a structure in which an optical disc rotates at a linear constant velocity, a trace length during the still operation can be made constant, whereby an effect of reducing deterioration of a substrate of the optical disc caused by the still operation, according to the present invention, can be made uniform both on outer and inner parts of an optical disc.

Although the present invention has been described referring to the preferred embodiments, the present invention is not limited to these embodiments, and those skilled in the art will appreciate that the present invention can be modified in various ways within the scope of the spirit thereof.

1. An optical disc apparatus capable of performing a still operation for an optical disc, the optical disc being provided with tracks, the tracks being formed so as to increase by a single track every circulation of the optical disc; said apparatus comprising:
a control unit obtaining a trace progress after start of said still operation and controlling, when said trace progress attains a predetermined value (said predetermined value>an equivalent value for one track), said pickup to perform the track-jump so that said pickup is placed back by at least said predetermined value toward the start position of reading the optical disc.

2. The optical disc apparatus according to claim 1, wherein said apparatus further comprises a circulation-number counter counting a circulation number of the optical disc;
said control unit obtaining an accumulated-circulation-number of the optical disc as said trace progress after start of said still operation from said circulation-number counter and controlling, when said accumulated-circulation-number attains a predetermined circulation number n (n>1) as said predetermined value, said pickup to perform the track-jump so that said pickup is placed back by n tracks toward the start position of reading the optical disc.

3. The optical disc apparatus according to claim 2, further comprising a memory storing said predetermined circulation number n.

4. The optical disc apparatus according to claim 3, wherein said control unit comprises:
an accumulated-circulation-number recognizing unit recognizing whether or not a counted value of said circulation-number counter attains said predetermined circulation-number n stored in said memory;
a track-jump unit causing, when said accumulated-circulation-number recognizing unit recognizes that said counted value of said circulation-number counter attains said predetermined circulation-number n stored in said memory, said pickup to perform the track-jump so that said pickup is placed back by n tracks toward the start position of reading the optical disc; and
a counter-resetting unit resetting said counted value of said circulation-number counter when said track-jump unit causes said pickup to perform the track-jump.

5. The optical disc apparatus according to claim 1, further comprising a circulation-number counter counting a circulation number of the optical disc;
said control unit obtaining an accumulated-circulation-number of the optical disc as said trace progress after start of said still operation from said circulation-number counter and controlling, when said accumulated-circulation-number attains a predetermined circulation number n (n>1) as said predetermined value, said pickup to perform the track-jump so that said pickup is placed back by (n+α) tracks (α≧1) toward the start position of reading the optical disc.

6. The optical disc apparatus according to claim 5, further comprising a first memory storing said predetermined circulation-number n and α a second memory storing said number α of additional tracks.

7. The optical disc apparatus according to claim 6, wherein said control unit comprises:
an accumulated-circulation-number recognizing unit recognizing whether or not a counted value of said circulation-number counter attains said predetermined circulation-number n stored in first said memory;
a track-jump unit, when said accumulated-circulation-number recognizing unit recognizes that said counted value of said circulation-number counter attains said predetermined circulation-number n stored in said first memory, said pickup to perform the track-jump so that said pickup is placed back by (n+α) tracks toward the start position of reading the optical disc, with referring to said second memory; and
a counter-resetting unit resetting said counted value of said circulation-number counter when said track-jump unit causes said pickup to perform the track-jump.

8. The optical disc apparatus according to claim 7, further comprising a third memory temporarily storing an original address upon start of a still operation;
said control unit further comprising an address-verifying unit, said address-verifying unit verifying, when said counter-resetting unit resets a counted value of said circulation-number counter, the original address stored in said third memory with an address after said track-jump and causing, if the verification result is satisfactory, said circulation-number counting unit to start counting.

9. The optical disc apparatus according to claim 1, further comprising a timer measuring a trace time during said still operation;
said control unit obtaining an elapsed-trace-time as said trace progress after start of said still operation from said timer, further obtaining, when said elapsed-trace-time attains a predetermined time t, a rotation speed r per unit time of the optical disc, and controlling said pickup to perform the track-jump so that said pickup is placed back by (r×t) tracks ((r×t)>1) toward the start position of reading the optical disc.

10. The optical disc apparatus according to claim 9, further comprising a memory storing said predetermined time t and a tachometer detecting said rotation speed r.

11. The optical disc apparatus according to claim 10, wherein said control unit comprises:
an elapsed-time recognizing unit recognizing whether or not said elapsed-trace-time measured by said timer attains said predetermined time t stored in said memory;
a track-jump unit referring, when said elapsed-time recognizing unit recognizes that said elapsed-trace-time measured by said timer attains said predetermined time t stored in said memory, to said rotation speed r measured by said tachometer and causing said pickup to perform the track-jump so that said pickup is placed back by (r×t) tracks toward the start position of reading the optical disc; and
a timer-resetting unit resetting a measured time of said timer when said track-jump unit causes said pickup to perform the track-jump.

12. The optical disc apparatus according to claim 1, further comprising a timer measuring a trace time during said still operation;
said control unit obtaining said elapsed-trace-time as said trace progress after start of said still operation from said timer, further obtaining, when said elapsed-trace-time attains a predetermined time t, a rotation speed r per unit time of the optical disc, and controlling said pickup to perform the track-jump so that said pickup is placed back by (r×t+α) tracks ((r×t)>1, α>1) toward the start position of reading the optical disc.

13. The optical disc apparatus according to claim 12, further comprising:
a first memory storing said predetermined time t;
a second memory storing said number α of additional tracks; and
a tachometer detecting said rotation speed r.

14. The optical disc apparatus according to claim 13, wherein said control unit comprises:
an elapsed-time recognizing unit recognizing whether or not said elapsed-trace-time measured by said timer attains said predetermined time t stored in said memory;
a track-jump unit referring, when said elapsed-time recognizing unit recognizes that said elapsed-trace-time measured by said timer attains said predetermined time t stored in said first memory, to said rotation speed r measured by said tachometer, further referring to said second memory, and causing said pickup to perform the track-jump so that said pickup is placed back by (r×t+α) tracks toward the start position of reading the optical disc; and
a timer-resetting unit resetting a measured time of said timer when said track-jump unit causes said pickup to perform the track-jump.

15. The optical disc apparatus according to claim 14, further comprising a third memory temporarily storing an original address upon start of a still operation;
said control unit further comprising an address-verifying unit, said address-verifying unit verifying, when said timer-resetting unit resets a counted value of said circulation-number timer, the original address stored in said third memory with an address after said track-jump and causing, if the verification result is satisfactory, said timer to start measuring a time.

16. A method for performing a still operation of an optical disc apparatus capable of performing a still operation for an optical disc, the optical disc being provided with tracks, the tracks being formed so as to increase by a single track every circulation of the optical disc, comprising the steps of:
obtaining a trace progress after start of said still operation; and
controlling, when said trace progress attains a predetermined value (said predetermined value>an equivalent value for one track), said pickup to perform the track-jump so that said pickup is placed back by at least said predetermined value toward the start position of reading the optical disc.

17. The method for performing a still operation according to claim 16, using a circulation-number counter counting a circulation number of the optical disc, the method further comprising the steps of:
obtaining an accumulated-circulation-number of the optical disc as said trace progress after start of said still operation from said circulation-number counter; and
controlling, when said accumulated-circulation-number attains a predetermined circulation number n (n>1) as said predetermined value, said pickup to perform the track-jump so that said pickup is placed back by n tracks toward the start position of reading the optical disc.

18. The method for performing a still operation according to claim 16, using a circulation-number counter counting a circulation number of the optical disc, the method further comprising the steps of:
obtaining an accumulated-circulation-number of the optical disc as said trace progress after start of said still operation from said circulation-number counter; and
controlling, when said accumulated-circulation-number attains a predetermined circulation number n (n>1) as said predetermined value, said pickup to perform the track-jump so that said pickup is placed back by (n+α) tracks (α≧1) toward the start position of reading the optical disc.

19. The method for performing a still operation according to claim 16, using a timer measuring a trace time during said still operation, the method further comprising the steps of:
obtaining an said elapsed-trace-time as said trace progress after start of said still operation from said timer;
further obtaining, when said elapsed-trace-time attains a predetermined time t, a rotation speed r per unit time of the optical disc; and
controlling said pickup to perform the track-jump so that said pickup is placed back by (r×t) tracks ((r×t)>1) toward the start position of reading the optical disc.

20. The method for performing a still operation according to claim 16, using a timer measuring a trace time during said still operation, the method further comprising the steps of:
obtaining said elapsed-trace-time as said trace progress after start of said still operation from said timer;
further obtaining, when said elapsed-trace-time attains a predetermined time t, a rotation speed r per unit time of the optical disc; and
controlling said pickup to perform the track-jump so that said pickup is placed back by (r×t+α) tracks ((r×t)>1, α>1) toward the start position of reading the optical disc.

21. A computer program for an optical disc apparatus capable of performing a still operation for an optical disc, the optical disc being provided with tracks, the tracks being formed so as to increase by a single track every circulation of the optical disc, comprising the steps of:
obtaining a trace progress after start of said still operation; and
controlling, when said trace progress attains a predetermined value (said predetermined value>an equivalent value for one track), said pickup to perform the track-jump so that said pickup is placed back by at least said predetermined value toward the start position of reading the optical disc.

22. The computer program according to claim 21, using a circulation-number counter counting a circulation number of the optical disc, the program further comprising the steps of:
obtaining an accumulated-circulation-number of the optical disc as said trace progress after start of said still operation from said circulation-number counter; and
controlling, when said accumulated-circulation-number attains a predetermined circulation number n (n>1) as said predetermined value, said pickup to perform the track-jump so that said pickup is placed back by n tracks toward the start position of reading the optical disc.

23. The computer program according to claim 21, using a circulation-number counter counting a circulation number of the optical disc, the program further comprising the steps of:
obtaining an accumulated-circulation-number of the optical disc as said trace progress after start of said still operation from said circulation-number counter; and
controlling, when said accumulated-circulation-number attains a predetermined circulation number n (n>1) as said predetermined value, said pickup to perform the track-jump so that said pickup is placed back by (n+α) tracks (α>1) toward the start position of reading the optical disc.

24. The computer program according to claim 21, using a timer measuring a trace time during said still operation, the program further comprising the steps of:
obtaining an said elapsed-trace-time as said trace progress after start of said still operation from said timer;
further obtaining, when said elapsed-trace-time attains a predetermined time t, a rotation speed r per unit time of the optical disc; and
controlling said pickup to perform the track-jump so that said pickup is placed back by (r×t) tracks ((r×t)>1) toward the start position of reading the optical disc.

25. The computer program according to claim 21, using a timer measuring a trace time during said still operation, the program further comprising the steps of:
obtaining said elapsed-trace-time as said trace progress after start of said still operation from said timer;
further obtaining, when said elapsed-trace-time attains a predetermined time t, a rotation speed r per unit time of the optical disc; and
controlling said pickup to perform the track-jump so that said pickup is placed back by (r×t+α) tracks ((r×t)>1, α>1) toward the start position of reading the optical disc.
